(19) United States
(12) Patent Application Publication
(10) Pub. No.: US 2020/0097601 A1
(43) Pub. Date: Mar. 26, 2020

(54) IDENTIFICATION OF AN ENTITY REPRESENTATION IN UNSTRUCTURED DATA

(71) Applicant: Accenture Global Solutions Limited, Dublin (IE)

(72) Inventors: Jingguang HAN, Dublin (IE); Dadong WAN, Palatine (IL); Edward Philip BURGIN, Nottingham (GB)

(21) Appl. No.: 16/143,014

(22) Filed: Sep. 26, 2018

(51) Int. Cl. G06F 17/30; G06N 99/00

(52) U.S. Cl. CPC G06F 17/30707; G06F 17/30598; G06F 17/30604; G06N 99/005; G06F 17/30958

(57) ABSTRACT

An example method may include receiving unstructured data; identifying a first plurality of entities in the unstructured data; identifying first relationships associated with the first plurality of entities using an entity relation model; receiving structured data; identifying a second plurality of entities in the structured data; identifying second relationships associated with the second plurality of entities using the entity relation model; generating a knowledge graph that is representative of the first plurality of entities, wherein the first relationships are associated with the first plurality of entities and the second relationships are associated with the second plurality of entities; determining a probability that a first node from the knowledge graph and a second node from the knowledge graph corresponds to a same entity; and performing an action associated with the probability that the first node and the second node corresponds to the same entity.

### BACKGROUND

A knowledge graph may be used to represent, name, and/or define a particular category, property, or relation between classes, topics, data, and/or entities of a domain. A knowledge graph may include nodes that represent the classes, topics, data, and/or entities of a domain and edges linking the nodes that represent a relationship between the classes, topics, data, and/or entities of the domain. Knowledge graphs may be used in classification systems, machine learning, computing, and/or the like.

### SUMMARY

According to some implementations, a method may include receiving unstructured data; identifying a first plurality of entities in the unstructured data; identifying first relationships associated with the first plurality of entities using an entity relation model; generating first knowledge graph that is representative of the first relationships associated with the first plurality of entities; receiving structured data; identifying a second plurality of entities in the structured data; identifying second relationships associated with the second plurality of entities using the entity relation model; generating a second knowledge graph that is representative of the second relationships associated with the second plurality of entities; determining a probability that a first entity from the first plurality of entities corresponds to a second entity from the second plurality of entities based on the first knowledge graph and the second knowledge graph; and performing an action associated with the probability that the first entity corresponds to the second entity.

According to some implementations, a device may include one or more memories; and one or more processors, communicatively coupled to the one or more memories, to: receive unstructured data; identify a first entity in the unstructured data; determine a first set of characteristics of the first entity based on entity information in the unstructured data; generate a first knowledge graph associated with the first entity, wherein the first knowledge graph includes a first internal node, for the first entity, that is linked by corresponding first edges to first external nodes corresponding to the first set of characteristics; receive structured data; identify a second entity in the structured data; determine a second set of characteristics of the second entity based on the structured data; generate a second knowledge graph associated with the second entity, wherein the second knowledge graph includes a second internal node, for the second entity, that is linked by corresponding second edges to second external nodes corresponding to the second set of characteristics; analyze the first knowledge graph and the second knowledge graph using an entity resolution model, wherein the entity resolution model is configured to determine a probability that the first entity corresponds to the second entity based on the first knowledge graph and the second knowledge graph; and perform an action associated with the probability that the first entity corresponds to the second entity.

According to some implementations, non-transitory computer-readable medium may store instructions that, when executed by one or more processors, cause the one or more processors to: obtain unstructured data; identify a plurality of entities in the unstructured data using an entity recognition model; identify relationships among the plurality of entities using an entity relation model; generate a first knowledge graph that is representative of the relationships among the plurality of entities; receive structured data associated with a characteristic of the unstructured data; identify an entity in the structured data using the entity recognition model; determine a set of characteristics of the entity based on the structured data using the entity relation model, wherein the set of characteristics includes a relationship between the entity and another entity of the structured data; generate a second knowledge graph based on the set of characteristics, wherein the second knowledge graph is associated with the entity and the other entity; determine, using an entity resolution model, a probability that the entity corresponds to a first entity of the plurality of entities based on the first knowledge graph and the second knowledge graph; and perform an action associated with the probability that the entity corresponds to the first entity of the plurality of entities.

### BRIEF DESCRIPTION OF THE DRAWINGS

FIG. 1 is a diagram of an example implementation described herein.

FIGS. 2A-2C include diagrams of example knowledge graphs that may be used in an example implementation, described herein.

FIG. 3 is a diagram of an example environment in which systems and/or methods, described herein, may be implemented.

FIG. 4 is a diagram of example components of one or more devices of FIG. 3.

FIGS. 5-7 are flow charts of example processes for identifying an entity representation in unstructured data.

### DETAILED DESCRIPTION

The following detailed description of example implementations refers to the accompanying drawings. The same reference numbers in different drawings may identify the same or similar elements.

Recognizing an entity within data may be useful in various applications, such as a know your customer (KYC) application, a fraud detection application, data mining, e-discovery, and/or the like. The data may be structured data (e.g., that is organized according to one or more parameters), such as data in a database, a table, an index, a task graph, and/or the like. Additionally, or alternatively, the data may be unstructured data (e.g., data that is not organized according to a particular parameter), such as data from an article (e.g., an online article), data from a website, data from a social media platform, data from files of a database, and/or the like. In some instances, an entity within the structured data may be associated with an entity within the unstructured data. For example, a person from an organization may be listed in a directory of the organization (in structured data) and may be the subject of an online news article and/or social media post (unstructured data). In some instances, the person may be identified using one name in the structured data and a different name in the unstructured data (e.g., a formal name in the directory and a nickname in the online news article or social media post). Furthermore, a plurality of entities may be identified by a same name or set of names (e.g., names that are common to two or more people).

Some implementations described herein include an entity analysis platform that is configured to identify entities in unstructured data and determine a probability that the entity in the unstructured data corresponds to an entity in structured data based on one or more characteristics and/or relationships of the entity. According to some implementations, the example entity analysis platform analyzes the unstructured data and the structured data to identify entities, determines relationships between the identified entities, and identifies possible representations of the entities of the structured data within the unstructured data. In such cases, the entity analysis platform may attribute information from the unstructured data to be associated with entities in the structured data (e.g., by applying and/or adding the information to the structured data). Accordingly, in such cases, a profile of an entity may be enhanced, and/or an amount of information associated with an entity in the structured data can be updated and/or increased.

In some implementations, the entity analysis platform may include and/or receive the unstructured data from one or more crawling devices (e.g., one or more web crawlers) that are configured to automatically (e.g., without user intervention or using manual processes) obtain the unstructured data from one or more platforms (e.g., online platforms such as websites, social media platforms, online data streams, and/or the like). The entity analysis platform may automatically identify entities in the unstructured data and obtain structured data that includes a plurality of known entities. In some implementations, the analysis platform may automatically obtain the structured data based on a characteristic of the unstructured data (e.g., a topic of the unstructured data, an entity or organization identified in the unstructured data, a location identified in the unstructured data, an event identified in the unstructured data, and/or the like). Furthermore, the entity analysis platform may identify relationships between entities of the unstructured data and/or structured data. For example, the entity analysis platform may use one or more natural language processing techniques to identify an entity and a relationship between that entity and one or more other entities described in the unstructured data. In some implementations, the entity analysis platform may generate one or more knowledge graphs associated with and/or based on the identified entities and relationships of the entities in the unstructured data and/or structured data. The entity analysis platform may automatically determine a probability that an entity of the unstructured data corresponds to an entity of the structured data, as described herein. Furthermore, the entity analysis platform may update the structured data to include information, associated with the entity, from the unstructured data. Accordingly, as a specific example, if the entity from the online news article or social media post is receiving an award (or positive sentiment), a profile of the entity in the directory can be updated to indicate that award. Similarly, negative sentiment can be indicated to the profile of the entity based on information in another news article or another social media post (e.g., the news article and/or social media post indicates the entity committed a crime).

In this way, several different stages of a process for identifying an entity representation in unstructured data are automated, which may remove human subjectivity and waste from the process, and which may improve speed and efficiency of the process and conserve computing resources (e.g., processor resources, memory resources, and/or the like). Furthermore, implementations described herein use a rigorous, computerized process to perform tasks or roles that were not previously performed or were previously performed using subjective human intuition or input. For example, currently there does not exist a technique to detect one or more entities in unstructured data, determine relationships between the entities within the unstructured data, and identify entity representations in the unstructured data (e.g., based on analysis of entities in structured data). Accordingly, computing resources associated with analyzing and/or representing one or more entities without information identified in unstructured data, as described herein, can be conserved. Finally, automating the process for identifying an entity representation in unstructured data using structured data, as described herein, conserves computing resources (e.g., processor resources, memory resources, and/or the like) that would otherwise be wasted by a user scanning through the unstructured data to identify the entity representation.

It is noted, that although examples and implementations described herein may refer to entities as people or individuals, an entity may be something other than a person or individual. For example, an entity may be an organization, a location, an event, an animal, a plant, an object, and/or any other type of thing can be identified.

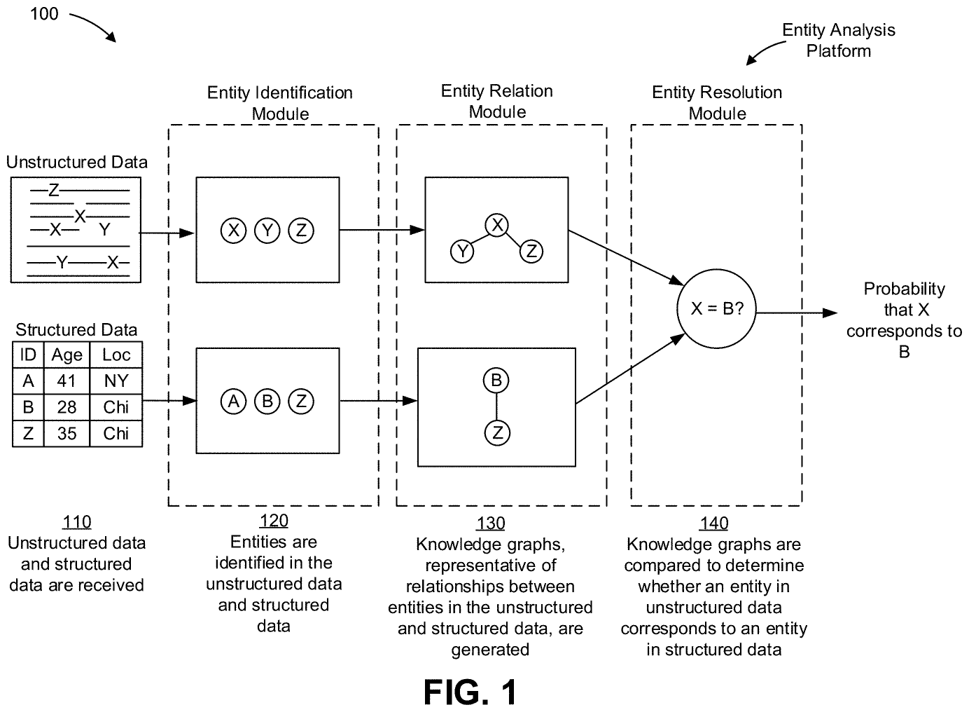

FIG. 1 is a diagram of an example implementation 100 described herein. Example implementation 100 may be associated with and/or implemented via an entity analysis platform configured to identify entities in unstructured and/or structured data, determine characteristics and/or relationships associated with the entities, and identify representations of entities (e.g., known entities from the structured data) within the unstructured data. As shown, the entity analysis platform may include an entity identification module, an entity relation module, and an entity resolution module. As described herein, the entity identification module may be configured to identify entities within structured and/or unstructured data, the entity relation module may be configured to determine one or more relationships between identified entities, and the entity resolution module may be configured to identify whether a representation of an entity in the unstructured data corresponds to an entity identified in the structured data.

As described herein, the entity analysis platform may use one or more artificial intelligence techniques, such as machine learning, deep learning, and/or the like to determine a probability that a potential identified entity in unstructured data and/or structured data is an entity, a probability that the entity is related to one or more entities, and/or a probability that the entity corresponds to another entity (e.g., an entity in the structured data).

In some implementations, the entity analysis platform may parse natural language descriptions of individuals, organizations, locations, events, and/or the like that may be representative of entities. For example, the entity analysis platform may obtain data identifying, in natural language, a description of an entity, and may parse the data to identify the entity, characteristics of the entity, relationships of the entity, and/or the like.

In some implementations, the entity analysis platform may determine a characteristic of an entity based on natural language processing of the unstructured data, which may include a description of the entity. For example, based on a description of an entity being “Robert Doe works for ABC Company”, the entity analysis platform may use natural language processing to determine that a characteristic of Robert Doe is that he is associated with ABC Company. Similarly, based on a description of the entity describing “Robert Doe celebrated with Mike Smith in Illinois”, the entity analysis platform may use natural language processing to determine characteristics of Robert Doe, such as Robert Doe has an associate (“Mike Smith”), is associated with a location (“Illinois”), has performed an activity (“celebrated”), and/or the like. In this case, the entity analysis platform may determine that a natural language text corresponds to a characteristic based on data relating to other entities, data identifying characteristics of entities, and/or the like. In this way, the entity analysis platform may identify characteristics associated with recognizing entities (e.g., using names, word formatting, sentence structure, and/or the like), determining entity relationships and/or characteristics of entities, and/or identifying entity representations, as described herein. Based on applying a rigorous and automated process associated with identifying entity representations, the entity analysis platform enables recognition and/or identification of thousands or millions or more identifiers (e.g., formal names, nicknames, brands, logos, and/or the like), relationships, and/or characteristics for thousands or millions or more entities, thereby increasing an accuracy and consistency of entity representation identification relative to requiring computing resources to be allocated for hundreds or thousands of technicians to manually identify entity representations of the thousands or millions or more entities.

In some implementations, the entity analysis platform may determine whether an entity is associated with one or more entity representations (e.g., identifiers), as described herein. For example, using data associated with an entity, the entity analysis platform may determine whether a representation is associated with the entity (e.g., if the entity is associated with a particular identifier). In this case, the entity analysis platform may generate a model of entity representation analysis. For example, the entity analysis platform may train a model using information that includes a plurality of identifiers of entities (e.g., formal names, nicknames, brands, logos, and/or the like), a plurality of characteristics associated with the entities, and/or the like, to identify whether a representation of an entity is associated with a particular entity and/or a probability that a representation of an entity is associated with the particular entity. As an example, the entity analysis platform may determine that past identifications of representations of entities, are associated with a threshold probability of being associated with the particular entity. In this case, the entity analysis platform may determine that a relatively high score (e.g., as being likely to be identified) is to be assigned to representations of entities that are determined to be the same or similar as previously identified representations of the particular entity (or more frequently identified than past identified representations). In contrast, the entity analysis platform may determine that a relatively low score (e.g., as being unlikely to be identified) is to be assigned to representations of entities that are determined to be different than past identified representations of the particular entity (or less frequently identified than past identified representations).

In some implementations, the entity analysis platform may perform a data preprocessing operation when generating the model of entity representation analysis. For example, the entity analysis platform may preprocess data (e.g., entity identifiers, entity characteristics, entity relationships, and/or the like) to remove non-ASCII characters, white spaces, confidential data (e.g., personal identification information (e.g., social security numbers, driver's license numbers, passport numbers, and/or the like), and/or the like). In this way, the entity analysis platform may organize thousands, millions, or billions of data entries for machine learning and model generation—a data set that cannot be processed objectively by a human actor.

In some implementations, the entity analysis platform may perform a training operation when generating the model of entity representation analysis. For example, the entity analysis platform may portion the data (e.g., structured data or unstructured data) into a training set, a validation set, a test set, and/or the like. In some implementations, the entity analysis platform may train the model of entity representation analysis using, for example, an unsupervised training procedure based on the training set of the data. For example, the entity analysis platform may perform dimensionality reduction to reduce the data to a minimum feature set, thereby reducing processing to train the model of entity representation analysis, and may apply a classification technique, to the minimum feature set.

In some implementations, the entity analysis platform may use a logistic regression classification technique to determine a categorical outcome (e.g., that an entity representation is associated with a particular entity, is not associated with a particular entity, and/or the like). Additionally, or alternatively, the entity analysis platform may use a naïve Bayesian classifier technique. In this case, the entity analysis platform may perform binary recursive partitioning to split the data of the minimum feature set into partitions and/or branches and use the partitions and/or branches to perform predictions (e.g., that a representation is or is not associated with a particular entity). Based on using recursive partitioning, the entity analysis platform may reduce utilization of computing resources relative to manual, linear sorting and analysis of data points, thereby enabling use of thousands, millions, or billions of data points to train a model, which may result in a more accurate model than using fewer data points.

Additionally, or alternatively, the entity analysis platform may use a support vector machine (SVM) classifier technique to generate a non-linear boundary between data points in the training set. In this case, the non-linear boundary is used to classify test data (e.g., data relating an identifier of a representation of an entity) into a particular class (e.g., a class indicating that the representation may be associated with an entity, a class indicating that the representation is not associated with an entity, and/or the like).

Additionally, or alternatively, the entity analysis platform may train the model of entity representation analysis using a supervised training procedure that includes receiving input to the model from a subject matter expert, which may reduce an amount of time, an amount of processing resources, and/or the like to train the model of entity representation analysis relative to an unsupervised training procedure. In some implementations, the entity analysis platform may use one or more other model training techniques, such as a neural network technique, a latent semantic indexing technique, and/or the like. For example, the entity analysis platform may perform an artificial neural network processing technique (e.g., using a two-layer feedforward neural network architecture, a three-layer feedforward neural network architecture, and/or the like) to perform pattern recognition with regard to patterns of whether representations of entities described using different semantic descriptions are associated with a particular entity or not. In this case, using the artificial neural network processing technique may improve an accuracy of a model generated by the entity analysis platform by being more robust to noisy, imprecise, or incomplete data, and by enabling the entity analysis platform to detect patterns and/or trends undetectable to human analysts or systems using less complex techniques.

As an example, the entity analysis platform may use a supervised multi-label classification technique to train the model. For example, as a first step, the entity analysis platform may map representations to a particular entity. In this case, the representations may be characterized as associated with the particular entity or not associated with the particular entity based on characteristics of the representations (e.g., whether an identifier of the representation is similar or associated with an identifier of the entity) and an analysis of the representations (e.g., by a technician, thereby reducing processing relative to the entity analysis platform being required to analyze each activity). As a second step, the entity analysis platform may determine classifier chains, whereby labels of target variables may be correlated (e.g., in this example, labels may be representations of entities and correlation may refer to an association to a common entity). In this case, the entity analysis platform may use an output of a first label as an input for a second label (as well as one or more input features, which may be other data relating to the entities and/or representations of the entities), and may determine a likelihood that particular representation that includes a set of characteristics (some of which are associated with a particular entity and some of which are not associated with the particular entity) are associated with the particular entity based on a similarity to other representations that include similar characteristics. In this way, the entity analysis platform transforms classification from a multilabel-classification problem to multiple single-classification problems, thereby reducing processing utilization. As a third step, the entity analysis platform may determine a Hamming Loss Metric relating to an accuracy of a label in performing a classification by using the validation set of the data. For example, an accuracy with which a weighting applied to each characteristic and whether each characteristic is associated with the particular entity or not, results in a correct prediction of whether a representation that has each characteristic is associated with the particular entity, thereby accounting for differing amounts to which association of any one characteristic influences association of a representation to the particular entity. As a fourth step, the entity analysis platform may finalize the model based on labels that satisfy a threshold accuracy associated with the Hamming Loss Metric and may use the model for subsequent prediction of whether characteristics of a representation are to result in the representation being associated with a particular entity.

As another example, the entity analysis platform may determine, using a linear regression technique, that a threshold percentage of characteristics, in a set of characteristics, are not associated with a particular entity, and may determine that those characteristics are to receive relatively low association scores. In contrast, the entity analysis platform may determine that another threshold percentage of characteristics are associated with the particular entity and may assign a relatively high association score to those characteristics. Based on the characteristics being associated with the particular entity or not associated with the particular entity, the entity analysis platform may generate the model of entity representation analysis and may use the model of entity representation analysis for analyzing new characteristics (e.g., identifiers, locations, relationships, and/or the like) that the entity analysis platform identifies.

Accordingly, the entity analysis platform may use any number of artificial intelligence techniques, machine learning techniques, deep learning techniques, and/or the like to identify a representation of entity (e.g., in unstructured data), analyze the representation of the entity, and/or determine a probability that the representation of the entity corresponds to an entity (e.g., a known entity in structured data).

As shown in FIG. 1, and by reference number 110, unstructured data and structured data are received by the entity analysis platform. In some implementations, the unstructured data may be received via a crawling device (e.g., a web crawler), a data feed (e.g., a Rich Site Summary (RSS) feed, and/or the like), and/or the like. The unstructured data may include data associated with a website (e.g., data from webpages of the website), data associated with a social media platform (e.g., data from social media posts and/or profiles of the social media platform), data associated with an online data stream (e.g., data associated with a news feed, broadcast stream, and/or the like), and/or the like. In some implementations, the structured data may be received from one or more data structures storing the structured data. The structured data may be associated with a particular entity and may include data that is organized according to one or more parameters. For example, a directory of an organization may include structured data identifying a known set of entities (e.g., employees, associates, clients, customers, and/or the like), organized, for example, by name, department, location, and/or the like.

As shown in the example implementation 100 of FIG. 1, the unstructured data may include entities X, Y, and Z. The entities may be identified within the unstructured data based on identifiers (e.g. names) X, Y, and Z. For example, the unstructured data may be a news article with a story about X, Y, and Z receiving a particular award. The structured data of example implementation 100 may be a directory that identifies A, B, and Z and respective ages (41, 28, and 35) and locations (New York (N.Y.), Chicago (Chi), and Chicago (Chi)) of A, B, and Z.

In some implementations, the structured data may be obtained based on receiving the unstructured data. For example, the entity analysis platform may determine a particular characteristic of and/or information discussed in the unstructured data. Referring to the example above, the news article may discuss that X, Y, and Z are from ABC organization. In such an example, the entity analysis platform may obtain the directory with A, B, and Z (the structured data) from a data structure associated with ABC organization.

In this way, the entity analysis platform may receive the unstructured and structured data to permit the entity identification module to identify the entities within the unstructured and/or structured data.

In this way, the entity analysis platform may generate and/or train a model associated with identifying entity representations in unstructured data and/or structured data.

As further shown in FIG. 1, and by reference number 120, entities are identified in the unstructured data and the structured data. As shown, the entity recognition module may be used to identify entities within the unstructured data and the structured data. The entity recognition module may use and/or train an entity recognition model to identify the entities in the unstructured data and the structured data.

In some implementations, the entity recognition module may generate the entity recognition model and use the entity recognition model to recognize entities in the unstructured data and/or the structured data. For example, based on data relating to hundreds, thousands, millions, or more entities across multiple organizations and/or domains, the entity recognition module may determine whether an entity is present within the unstructured data and/or structured. In this case, the entity recognition model may be an item-based collaborative filtering model, a single value decomposition model, a hybrid recommendation model, and/or another type of model that enables recognition of one or more entities based on a characteristic, such as an identifier (e.g., a formal name, a nickname, a brand, a logo, and/or the like), a role of the entity, an age of the entity, an organization associated with the entity, a department associated with the entity, a location associated with the entity, a title associated with the entity, and/or the like. The entity recognition model may be generated as described above with regard to the model of entity representation analysis.

In some implementations, the entity recognition module may use a machine learning technique, a natural language processing technique, a heuristic technique, and/or the like to identify an entity in the unstructured data and/or the structured data. For example, the entity recognition module may use collaborative filtering (e.g., user based collaborative filtering or item based collaborative filtering) to identify an entity based on one or more known identifications of an entity, and may use an identification to determine relationships and/or characteristics of the entity, thereby enabling a representation of the entity to be identified in the unstructured data, and further enabling information from the unstructured data to be associated with the entity. In some implementations, the entity recognition module may use the machine learning technique to determine a probability that an identified potential entity is, in fact, an entity (e.g., an entity that is in structured data). The entity recognition module may use the machine learning technique to determine the probability, as described above with regard to the model of entity representation.

As shown in FIG. 1, the entity identification module may be configured to identify the entities X, Y, and Z in the unstructured data and the entities A, B, and Z in the structured data. For example, the entity recognition module may search for characteristics of identifiers associated with X, Y, Z, A, and B that are included within the unstructured data and/or structured data. Referring to the example above, the entity recognition module may identify capitalized words (e.g., pronouns) corresponding to names of X, Y, and Z that are in the news article. Further, the entity recognition module may refer to the identification column of the structured data to identify A, B, and Z in the structured data. Accordingly, the entity recognition module may recognize X, Y, Z, A, and B in the unstructured data and structured data.

In this way, the entity analysis platform may recognize entities within the unstructured data to determine a probability that the entities are associated with one another and/or associated with one or more characteristics.

As further shown in FIG. 1, and by reference number 130, one or more knowledge graphs, representative of relationships between the entities in the unstructured data and the structured data, are generated. As shown, the entity relation module may be used to generate the knowledge graphs to represent the relationships and/or characteristics of the entities. In some implementations, the knowledge graphs may be portions of a single knowledge graph and/or combined into a single knowledge graph. Additionally, or alternatively, the entity relation module may be use one or more other data structures to represent relationships between entities, such as a table, a database, an index, and/or the like.

The entity relation module may use and/or train an entity relation model to identify the relationships and/or characteristics of the entities and/or generate the knowledge graphs accordingly. In some implementations, the knowledge graphs may be generated based on probabilities that an entity is related to another entity and/or that the entity has one or more particular characteristics. In some implementations, the knowledge graphs may be included within one or more knowledge graphs and/or may be based on one or more other knowledge graph (e.g., a general or common knowledge graph). Accordingly, the knowledge graphs may be created specifically for the identified entities and/or generated as annotated knowledge graphs from another knowledge graph.

In some implementations, the entity relation module may generate the entity relation model and use the entity relation model to identify or determine relationships between the entities of the unstructured data and/or structured data. For example, based on data relating to hundreds, thousands, millions or more entities across multiple organizations and/or domains, the entity relation module may determine whether an entity is associated with another entity. In this case, the entity relation model may be an item-based collaborative filtering model, a single value decomposition model, a hybrid recommendation model, and/or another type of model that enables identification of a relationship between at least two entities based on one or more characteristics of the entities, such as a common identifier (e.g., entities have a same name or last name), a common organization (e.g., entities work for and/or with a same organization), a common location (e.g., entities are located and/or associated with a same location), a common event (e.g., entities that participated in or are associated with a same event), and/or the like. The entity relation model may be generated, as described above with regard to the model of entity representation analysis.

In some implementations, the entity relation module may use a machine learning technique, a natural language processing technique, a heuristic technique, and/or the like to identify relationships between entities and/or characteristics of entities in the unstructured data and/or the structured data. For example, the entity relation module may use collaborative filtering (e.g., user based collaborative filtering or item based collaborative filtering) to identify a relationship between entities based on one or more known or identifiable characteristics of the entities, and may use an identification to determine whether a representation of the entity in the unstructured data corresponds to an entity identified in the structured data, and further enabling information from the unstructured data to be associated with the entity. In some implementations, the entity relation module may use the machine learning technique to determine a probability that there is a relationship between the entities. The entity relation module may use the machine learning technique to determine the probability as described above with regard to the model of entity representation.

As shown in example implementation 100, the entity relation module may generate a knowledge graph for the entities identified in the unstructured data indicating that there is a relationship between X and Y and X and Z. Referring to the example of above, the news article may indicate that X with Y and that X was with Z when receiving the award. As shown, X is represented by an internal node of a knowledge graph, and Y and Z are represented by external nodes of the knowledge graph indicating that X is related (represented by edges or links) to Y and Z, but Y and Z may not be related to one another. In some implementations, the entity relation module may use the above machine learning technique, natural language processing technique, heuristic technique, and/or the like to analyze the unstructured data and determine a probability that X is related to Y and X is related to Z.

Furthermore, as shown in example implementation 100, the entity relation module may generate a knowledge graph for the entities identified in the structured data indicating that there is a relationship between B and Z. For example, as shown in the structured data, B and Z are located in a same location (Chi). Accordingly, as shown a relationship is represented between B and Z by linking a node representative of B with a node representative of Z.

In this way, the entity analysis platform may identify relationships and/or characteristics of entities within the unstructured data and/or structured data to determine a probability that entities have particular relationships and/or characteristics.

As further shown in FIG. 1, and by reference number 140, the knowledge graphs are compared to determine whether an entity in the unstructured data corresponds to an entity in the structured data. As shown, an entity resolution module may be used to determine whether an entity (or representation of an entity) in unstructured data corresponds to an entity in structured data based on relationships and/or characteristics of the entities of the unstructured data and/or structured data (as represented in the knowledge graphs). The entity resolution module may use and/or train an entity resolution model to determine whether (or determine a probability that) a representation of an entity in the unstructured data corresponds to an entity identified in the structured data. In some implementations, as shown, the entity resolution module may output a probability that the representation of an entity in the unstructured data corresponds to the entity in structured data.

In some implementations, the entity resolution module may generate the entity resolution model and use the entity resolution model to determine the probability that an entity (or representation of an entity) in the unstructured data corresponds to an entity identified in the structured data. For example, based on data relating to hundreds, thousands, millions or more entities or corresponding representations of entities across multiple organizations and/or domains, the entity resolution module may determine whether an entity corresponds to another entity and/or a probability that the entity corresponds to the other entity. In this case, the entity resolution model may be an item-based collaborative filtering model, a single value decomposition model, a hybrid recommendation model, and/or another type of model that enables a determination of whether a first entity corresponds to a second entity based on one or more characteristics of the first entity and the second entity, such as generated knowledge graphs indicating the entities are associated with one or more a common identifier, a common organization, a common location, a common event, and/or the like. The entity resolution model may be generated as described above with regard to the model of entity representation analysis.

In some implementations, the entity resolution module may use a machine learning technique, a natural language processing technique, a heuristic technique, and/or the like to determine whether a representation of an entity in the unstructured data corresponds to an entity identified in the structured data. For example, the entity resolution module may use collaborative filtering (e.g., user based collaborative filtering or item based collaborative filtering) to determine an entity in the unstructured data corresponds to an entity in the structured data, and may use that determination to obtain information from the unstructured data and associate that information the entity of the structured data (e.g., by updating one or more characteristics of the structured data). In some implementations, the entity resolution module may use the machine learning technique to determine a probability that the entity of the unstructured data corresponds to the entity of the structured data. The entity resolution module may use the machine learning technique to determine the probability, as described above with regard to the model of entity representation.

According to some implementations, the entity resolution module may store the probability that the entity of the unstructured data corresponds to the entity of the structured data (e.g., as a characteristic of an edge or relationship of nodes corresponding to the entities). In such cases, during a subsequent analysis, the stored probabilities may be used (e.g., by the machine learning technique) to determine a probability that the entities are associated with another entity and/or with each other. Accordingly, as the entity resolution module iteratively analyzes entities identified in unstructured data, the entities may be stored in the structured data along with probabilities that the entities correspond to other entities in the structured data. Furthermore, the probabilities may be iteratively updated for each identified entity within the unstructured data. As such, the machine learning technique may identify, over time and/or subsequent iterations, which entities in the structured data correspond to one another and which entities do not correspond to one another (e.g., using a threshold probability and/or a threshold number of analyses of the entity).

As shown in example implementation 100, the entity resolution module may determine whether X corresponds to B (or a probability that X corresponds to B). For example, the entity resolution module may compare the knowledge graphs associated with X and B and determine, based on the fact that both X and B are associated with or have a relationship with Z, that there is a higher probability that X and B correspond to one another. The entity resolution module may determine a high probability that X corresponds to B if X and B share one or more additional characteristics (e.g., have a same name (e.g., first name, last name, and/or the like), work for a same organization, are located in a same location, and/or the like) as can be determined from the unstructured data and the structured data.

In this way, the entity analysis platform may determine a probability that an entity (or a representation of an entity) identified in unstructured data corresponds to an entity identified in the structured data.

In some implementations, based on the probability that an entity (or representation of an entity) in the unstructured data corresponds to the entity in the structured data, the entity analysis platform may perform one or more actions. For example, if the probability satisfies a threshold probability (e.g., greater than 80% likelihood, 90% likelihood, 95% likelihood, and/or the like), the entity analysis platform may determine that the entities correspond to one another. In such a case, the entity analysis platform may update and/or include information within the structured data that is associated and/or obtained from the unstructured data. Referring to the example above, if the entity analysis platform determines that X corresponds to B, then the structured data for B may be updated to indicate that B received the award described in the news article.

In some implementations, the entity analysis platform may determine general sentiment from the unstructured data to determine whether a positive or negative attribute for the entity is to be included or identified in the structured data. For example, if the unstructured data is associated with a crime, the entity in the unstructured data may be identified as a criminal and/or associated with the crime (and thus should potentially be investigated in association with another crime). But, in the example described above, the identification that an entity received an award may indicate that the entity has a certain level of experience, expertise, and/or training (and thus should potentially be referred to for business).

In some implementations, the entity analysis platform may provide a report and/or information identifying probabilities that entities are associated with one another. In some implementations, the report may be generated according to the probabilities. In some implementations, the entity analysis platform may use certain probabilities (e.g., between 90% and 50%, between 99% and 80%, between 80% and 60%, and/or the like) to determine whether a user is to be notified that further analysis or review is to be performed. Accordingly, the entity analysis platform may send information identifying the probabilities that entities are related to one another.

Accordingly, as described herein, the entity analysis platform may automatically recognize one or more entities within unstructured data and determine a probability that the one or more entities corresponds to an entity in structured data. As such, the entity analysis platform may be used to update and/or increase an amount of information associated with an entity in the structured data using information from the unstructured data. As such, some implementations described herein enable objective analysis of unstructured data and/or use of the unstructured data to enhance a profile of an entity and/or gain information associated with an entity. Accordingly, as described herein, computing resources (e.g., processing resources, memory resources, power resources, and/or the like) that are wasted in association with searching for and/or identifying information associated with entity (e.g., via manual searching by a user) can be conserved.

As indicated above, FIG. 1 is provided merely as an example. Other examples are possible and may differ from what was described with regard to FIG. 1.

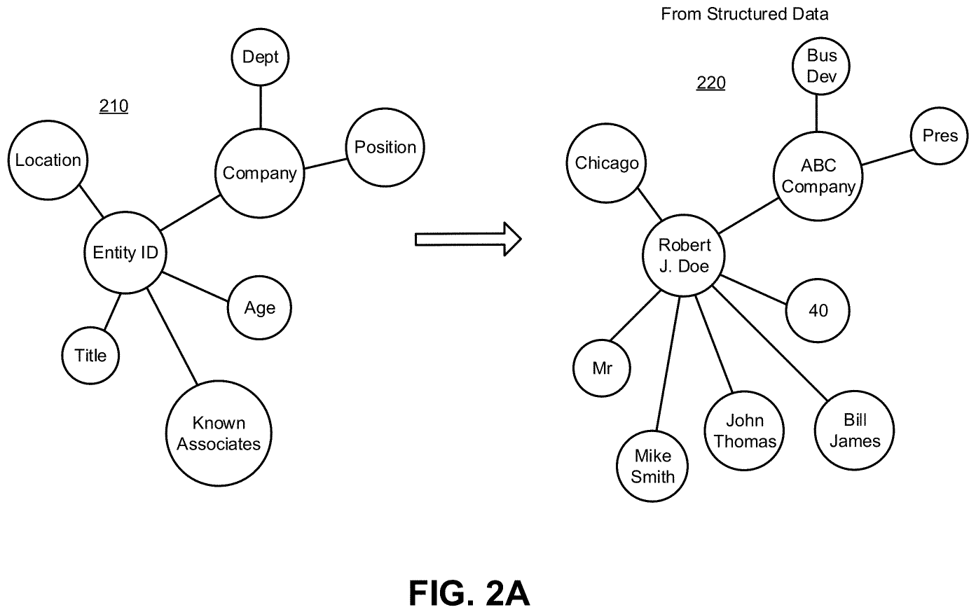

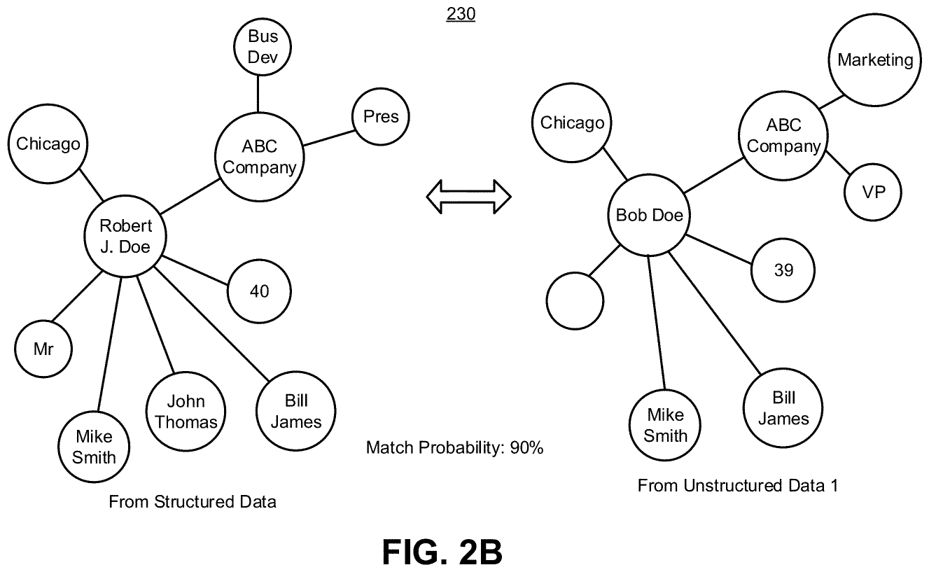

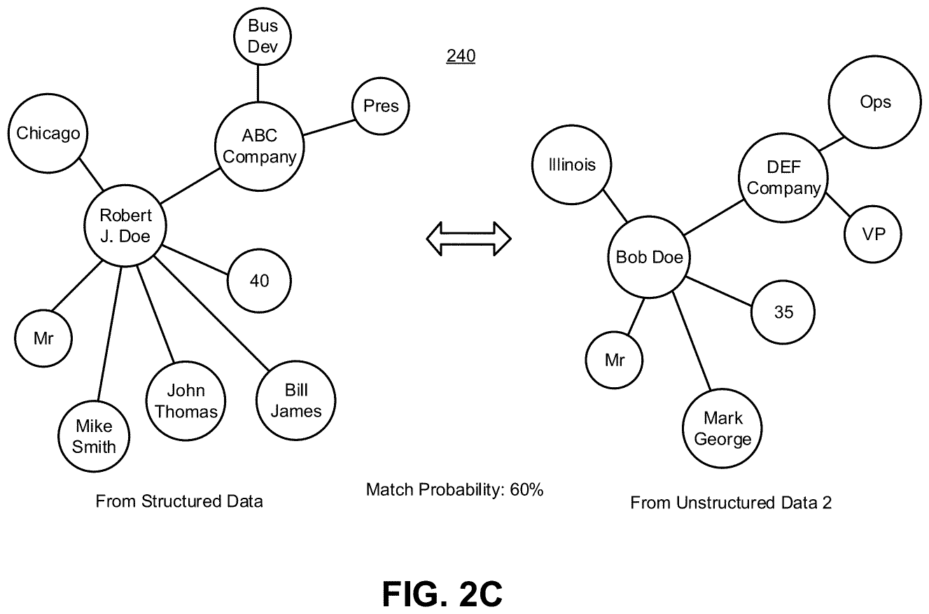

FIGS. 2A-2C include diagrams of example knowledge graphs that may be used in an example implementation, described herein. As described above in connection with FIG. 1, entity analysis platform may use knowledge graphs to compare an entity identified in unstructured data with an entity identified in structured data to determine whether the entities correspond to one another. Accordingly, entity analysis platform may use knowledge graphs as described in connection with example implementation.

As shown in FIG. 2A, and by reference number 210, a general knowledge graph may be used to identify particular characteristics and/or features of an entity. For example, the entity analysis platform (e.g., using the entity relation model), when analyzing the unstructured data and/or structured data, may search for particular characteristics as defined by the general knowledge graph. Accordingly, as shown the entity relation module, using the general knowledge graph, may search the unstructured data to identify one or more of an entity ID, a title of the entity, known associates of the entity, an age of the entity, a company and corresponding position or department, or location of the entity to generate a knowledge graph for the entity. In some implementations, certain weights may be applied to each of the characteristics of the general knowledge graph that may be used to calculate a probability that entities correspond to one another. For example, having a same name, related name, or same part of a name may be weighted more heavily than a location of the entity (e.g., because two representations with a same name indicate a higher probability that the representations are referring to a same entity than two differently named entities being in a same location).

Accordingly, as further shown in FIG. 2A, and by reference 220, the entity analysis platform (e.g., via the entity relation model) may analyze (using one or more of the techniques described above in connection with the model of entity representation analysis) the unstructured data and determine that a Mr. Robert J. Doe is 40 years old, is located in Chicago, is president of business development for ABC company, and is associated with Mike Smith, John Thomas, and Bill James. Accordingly, the entity analysis platform may use a general knowledge graph to search for and/or identify relationships or characteristics of an entity within unstructured data to generate a knowledge graph for that entity.

As shown in FIGS. 2B and 2C, the entity analysis platform (e.g., using the entity resolution module) may compare knowledge graphs associated with an entity from structured data (Robert J. Doe) and entities from unstructured data 1 and unstructured data 2 (both being Bob Doe). In some implementations, the entity analysis platform, using the techniques described herein, may have access to and/or include information that indicates that “Bob” is a nickname of “Robert.” Accordingly, the entity analysis platform may determine that Bob Doe potentially corresponds to Robert J. Doe. In such a case, the entity analysis platform may further analyze the structured data and/or unstructured data to generate the knowledge graphs as shown in FIGS. 2B and 2C.

As shown in FIG. 2B, and by reference number 230, from the knowledge graph for Robert J. Doe, the entity analysis platform may determine, from the structured data, that Mr. Robert J. Doe is 40 years old, is located in Chicago, is president of business development for ABC company, and is associated with Mike Smith, John Thomas, and Bill James. Further, the entity analysis platform may determine, from the unstructured data 1, that Bob Doe was 39 (e.g., at the time the unstructured data was generated), was located in Chicago, was vice president of marketing for ABC company, and was associated with Mike Smith and Bill James. Accordingly, because of the relatively high amount of matching or similar characteristics, the entity analysis platform, using the techniques described herein, may determine that there is a 90% probability that Bob Doe from unstructured data 1 corresponds to (or is) Robert J. Doe. In some implementations, the 90% probability may be stored in association with the relationship between Bob Doe and Robert J. Doe (e.g., as a characteristic of an edge between a Robert J. Doe node and Bob Doe node of a knowledge graph). Accordingly, for subsequent analyses involving Robert J. Doe and/or Bob Doe, the entity analysis platform may use the 90% probability to determine wither Robert J. Doe and/or Bob Doe correspond to another entity identified in unstructured data (e.g., Bob J. Doe, Rob Doe, and/or the like).

As shown in FIG. 2C, and by reference number 240, the entity analysis platform may determine, from unstructured data 2, that Bob Doe was 35, was located in Illinois, was vice president of operations for DEF company, and was associated with Mark George. Accordingly, because of the relatively fewer amount of matching or similar characteristics the entity analysis platform, using the techniques described herein, may determine that there is a 60% probability that Bob Doe from unstructured data 2 corresponds to (or is) Robert J. Doe. As described above, the 60% probability can be used for subsequent analyses involving Robert J. Doe and/or Bob Doe.

Accordingly, as described herein, the entity analysis platform may generate and use knowledge graphs to determine whether a representation of an entity in unstructured data corresponds to an entity identified in structured data.

As indicated above, FIGS. 2A-2C are provided merely as an example Other examples are possible and may differ from what was described with regard to FIGS. 2A-2C.

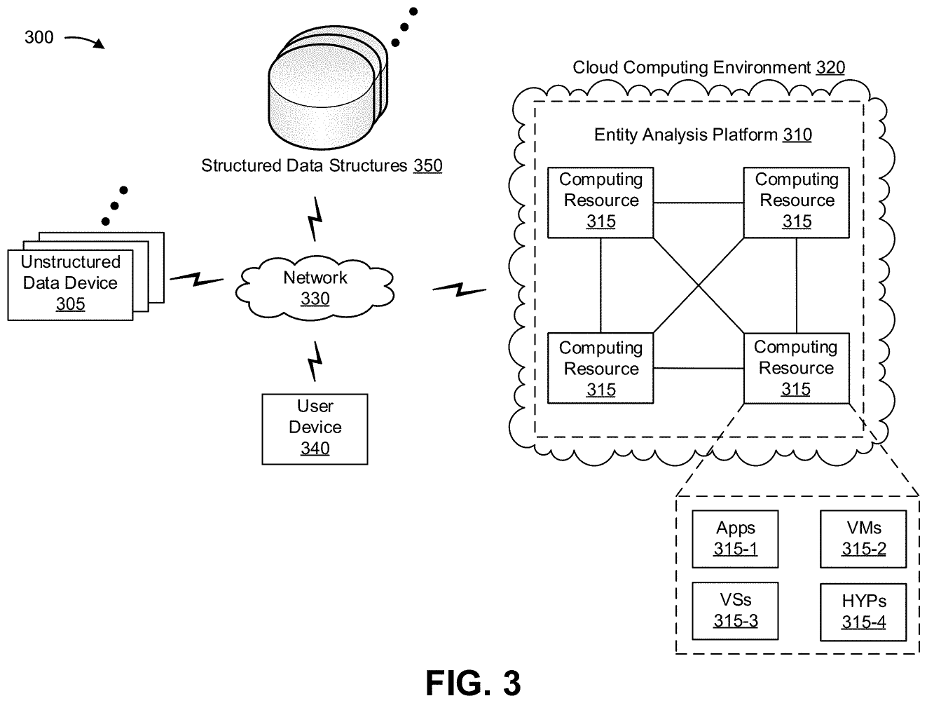

FIG. 3 is a diagram of an example environment 300 in which systems and/or methods, described herein, may be implemented. As shown in FIG. 2, environment 300 may include one or more unstructured data devices 305 (referred herein to individually as unstructured data device 305 and collectively as “unstructured data devices 305”), an entity analysis platform 310 hosted within a cloud computing environment 320, a network 330, a user device 340, and one or more structured data structures (referred herein to individually as “structured data structure 350” and collectively as “structured data structures 350”). Devices of environment 300 may interconnect via wired connections, wireless connections, or a combination of wired and wireless connections.

Unstructured data device 305 includes one or more devices configured to receive, generate, store, process, and/or provide unstructured data as described herein. For example, unstructured data device 305 may include one or more modules and/or devices capable of accessing one or more platforms to obtain unstructured data and/or providing data from the one or more platforms. For example, unstructured data device 305 may include a communication device and/or computing device, such as a desktop computer, a laptop computer, a server device, and/or a similar type of device. Unstructured data device 305 may include one or more crawling modules configured to access or crawl one or more of websites (or webpages of websites), social media platforms (or social media posts and/or messages of social media platforms), databases (e.g., online databases) storing unstructured data, and/or the like. Additionally, or alternatively, unstructured data device 305 may include a data feed device configured to forward and/or transmit unstructured data to entity analysis platform 310. Unstructured data device 305 may provide obtained unstructured data to entity analysis platform 310 to permit entity analysis platform 310 to detect entities within the unstructured data, determine relationships between entities within the unstructured data, and/or detect entity representations within the unstructured data, as described herein.

Entity analysis platform 310 includes one or more computing resources or devices capable of receiving, generating, storing, processing, and/or providing information associated with identifying an entity representation in unstructured data. For example, entity analysis platform 310 may be a platform implemented by cloud computing environment 320 that may detect entities within unstructured data (e.g., received via unstructured data device 305) and/or structured data (e.g., received from structured data structure 350), determine relationships between the entities, and/or determine entity representations (e.g., entities that correspond to one another) within the unstructured data and/or structured data. In some implementations, entity analysis platform 310 is implemented by computing resources 315 of cloud computing environment 320.

Entity analysis platform 310 may include a server device or a group of server devices. In some implementations, entity analysis platform 310 may be hosted in cloud computing environment 320. Notably, while implementations described herein describe entity analysis platform 310 as being hosted in cloud computing environment 320, in some implementations, entity analysis platform 310 may not be cloud-based or may be partially cloud-based.

Cloud computing environment 320 includes an environment that delivers computing as a service, whereby shared resources, services, etc. may be provided to user device 340. Cloud computing environment 320 may provide computation, software, data access, storage, and/or other services that do not require end-user knowledge of a physical location and configuration of a system and/or a device that delivers the services. As shown, cloud computing environment 320 may include entity analysis platform 310 and/or computing resources 315.

Computing resource 315 includes one or more personal computers, workstation computers, server devices, or another type of computation and/or communication device. In some implementations, computing resource 315 may entity analysis platform 310. The cloud resources may include compute instances executing in computing resource 315, storage devices provided in computing resource 315, data transfer devices provided by computing resource 315, etc. In some implementations, computing resource 315 may communicate with other computing resources 315 via wired connections, wireless connections, or a combination of wired and wireless connections.

As further shown in FIG. 3, computing resource 315 may include a group of cloud resources, such as one or more applications (“APPs”) 315-1, one or more virtual machines (“VMs”) 315-2, virtualized storage (“VSs”) 315-3, one or more hypervisors (“HYPs”) 315-4, or the like.

Application 315-1 includes one or more software applications that may be provided to or accessed by user device 340. Application 315-1 may eliminate a need to install and execute the software applications on user device 340. For example, application 315-1 may include software associated with entity analysis platform 310 and/or any other software capable of being provided via cloud computing environment 320. In some implementations, one application 315-1 may send/receive information to/from one or more other applications 315-1, via virtual machine 315-2.

Virtual machine 315-2 includes a software implementation of a machine (e.g., a computer) that executes programs like a physical machine. Virtual machine 315-2 may be either a system virtual machine or a process virtual machine, depending upon use and degree of correspondence to any real machine by virtual machine 315-2. A system virtual machine may provide a complete system platform that supports execution of a complete operating system (“OS”). A process virtual machine may execute a single program and may support a single process. In some implementations, virtual machine 315-2 may execute on behalf of a user (e.g., user device 340), and may manage infrastructure of cloud computing environment 320, such as data management, synchronization, or long-duration data transfers.

Virtualized storage 315-3 includes one or more storage systems and/or one or more devices that use virtualization techniques within the storage systems or devices of computing resource 315. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 315-4 provides hardware virtualization techniques that allow multiple operating systems (e.g., “guest operating systems”) to execute concurrently on a host computer, such as computing resource 315. Hypervisor 315-4 may present a virtual operating platform to the guest operating systems and may manage the execution of the guest operating systems. Multiple instances of a variety of operating systems may share virtualized hardware resources.

Network 330 includes one or more wired and/or wireless networks. For example, network 330 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

User device 340 includes one or more devices capable of receiving, generating, storing, processing, and/or providing information associated with detecting entities within unstructured data (e.g., received and/or obtained via unstructured data device 305). For example, user device 340 may include a communication and/or computing device, such as a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device. In some implementations, entity analysis platform 310 may provide information associated with entities identified within unstructured data provided via unstructured data device 305 and/or structured data provided from structured data structure 350.

Structured data structure 350 includes one or more devices capable of receiving, generating, storing, processing, and/or providing structured data, as described herein. For example, structured data structure 350 may include a database, a table, an index, a task graph, and/or the like. Structured data structure may store and/or provide structured data to entity analysis platform 310 to permit entity analysis platform 310 to identify one or more entities in the structured data, as described herein. In some implementations, structured data structure 350 may be associated with a particular organization, group, and/or the like that is associated with entities within the structured data stored by structured data structure 350. For example, the structured data may include a database (e.g., a directory) that identifies and/or stores information associated with one or more entities and/or one or more characteristics of the entities.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 2. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

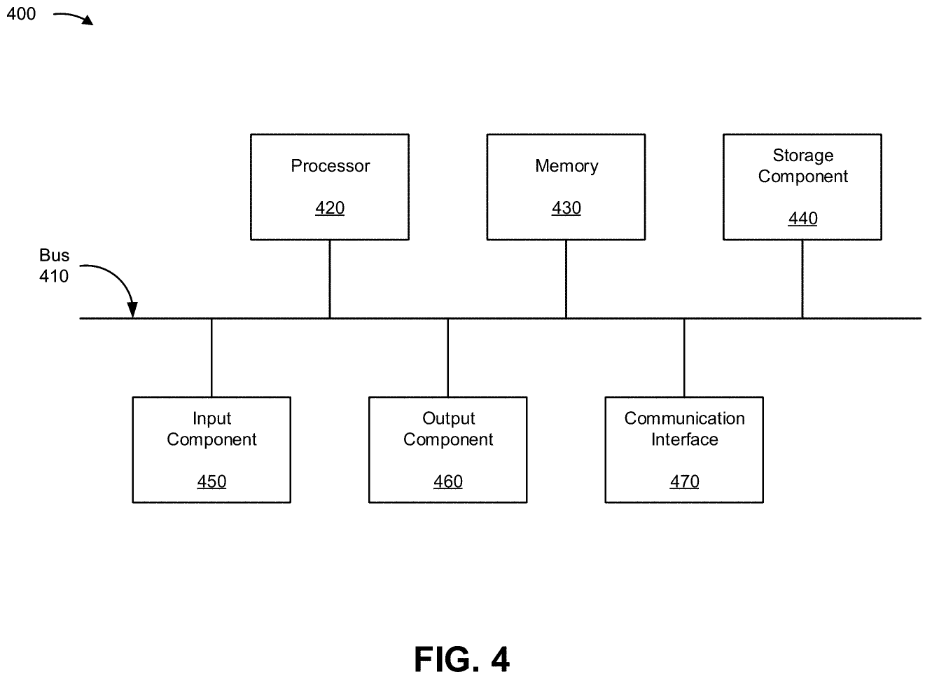

FIG. 4 is a diagram of example components of a device 400. Device 400 may correspond to unstructured data device 305, entity analysis platform 310, computing resource 315, and/or user device 340. In some implementations, unstructured data device 305, entity analysis platform 310, computing resource 315, and/or user device 340 may include one or more devices 400 and/or one or more components of device 400. As shown in FIG. 4, device 400 may include a bus 410, a processor 420, a memory 430, a storage component 440, an input component 450, an output component 460, and a communication interface 470.

Bus 410 includes a component that permits communication among the components of device 400. Processor 420 is implemented in hardware, firmware, or a combination of hardware and software. Processor 420 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 420 includes one or more processors capable of being programmed to perform a function. Memory 430 includes a random access memory (RAM), a read only memory (ROM), and/or another type of dynamic or static storage device (e.g., a flash memory, a magnetic memory, and/or an optical memory) that stores information and/or instructions for use by processor 420.

Storage component 440 stores information and/or software related to the operation and use of device 400. For example, storage component 440 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 450 includes a component that permits device 400 to receive information, such as via user input (e.g., a touch screen display, a keyboard, a keypad, a mouse, a button, a switch, and/or a microphone). Additionally, or alternatively, input component 450 may include a sensor for sensing information (e.g., a global positioning system (GPS) component, an accelerometer, a gyroscope, and/or an actuator). Output component 460 includes a component that provides output information from device 400 (e.g., a display, a speaker, and/or one or more light-emitting diodes (LEDs)).

Communication interface 470 includes a transceiver-like component (e.g., a transceiver and/or a separate receiver and transmitter) that enables device 400 to communicate with other devices, such as via a wired connection, a wireless connection, or a combination of wired and wireless connections. Communication interface 470 may permit device 400 to receive information from another device and/or provide information to another device. For example, communication interface 470 may include an Ethernet interface, an optical interface, a coaxial interface, an infrared interface, a radio frequency (RF) interface, a universal serial bus (USB) interface, a Wi-Fi interface, a cellular network interface, or the like.

Device 400 may perform one or more processes described herein. Device 400 may perform these processes based on to processor 420 executing software instructions stored by a non-transitory computer-readable medium, such as memory 430 and/or storage component 440. A computer-readable medium is defined herein as a non-transitory memory device. A memory device includes memory space within a single physical storage device or memory space spread across multiple physical storage devices.

Software instructions may be read into memory 430 and/or storage component 440 from another computer-readable medium or from another device via communication interface 470. When executed, software instructions stored in memory 430 and/or storage component 440 may cause processor 420 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

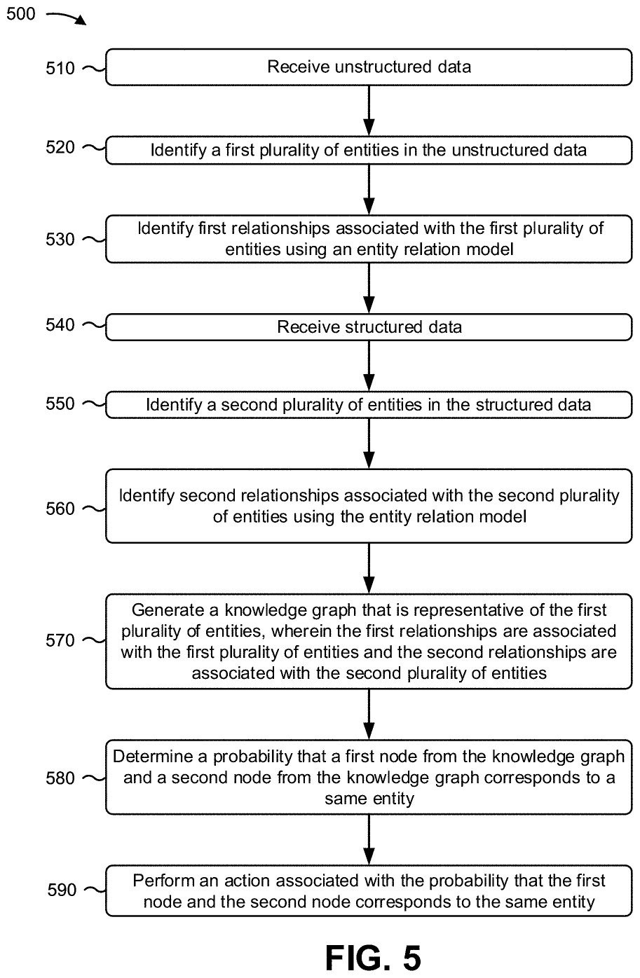

FIG. 5 is a flow chart of an example process 500 for identifying an entity representation in unstructured data. In some implementations, one or more process blocks of FIG. 5 may be performed by an entity analysis platform (e.g., entity analysis platform 310). In some implementations, one or more process blocks of FIG. 5 may be performed by another device or a group of devices separate from or including entity analysis platform 310, such as unstructured data device 305 and/or user device 340.

As shown in FIG. 5, process 500 may include receiving unstructured data (block 510). For example, the entity analysis platform (e.g., using computing resource 315, processor 420, memory 430, input component 450, communication interface 470, and/or the like) may receive unstructured data, as described above.

As further shown in FIG. 5, process 500 may include identifying a first plurality of entities in the unstructured data (block 520). For example, the entity analysis platform (e.g., using computing resource 315, processor 420, memory 430, and/or the like) may identify a first plurality of entities in the unstructured data, as described above.

As further shown in FIG. 5, process 500 may include identifying first relationships associated with the first plurality of entities using an entity relation model (block 530). For example, the entity analysis platform (e.g., using computing resource 315, processor 420, memory 430, and/or the like) may identify first relationships associated with the first plurality of entities using an entity relation model, as described above.

As further shown in FIG. 5, process 500 may include receiving structured data (block 540). For example, the entity analysis platform (e.g., using computing resource 315, processor 420, memory 430, input component 450, communication interface 470, and/or the like) may receive structured data, as described above.

As further shown in FIG. 5, process 500 may include identifying a second plurality of entities in the structured data (block 550). For example, the entity analysis platform (e.g., using computing resource 315, processor 420, memory 430, and/or the like) may identify a second plurality of entities in the structured data, as described above.

As further shown in FIG. 5, process 500 may include identifying second relationships associated with the second plurality of entities using the entity relation model (block 560). For example, the entity analysis platform (e.g., using computing resource 315, processor 420, memory 430, and/or the like) may identify second relationships associated with the second plurality of entities using the entity relation model, as described above.

As further shown in FIG. 5, process 500 may include a knowledge graph that is representative of the first plurality of entities, the first relationships associated with the first plurality of entities, and the second relationships associated with the second plurality of entities (block 570). For example, the entity analysis platform (e.g., using computing resource 315, processor 420, memory 430, and/or the like) may generate a knowledge graph that is representative of the first plurality of entities, as described above. In some implementations, the first relationships are associated with the first plurality of entities and the second relationships associated with the second plurality of entities.

As further shown in FIG. 5, process 500 may include determining a probability that a first node from the knowledge graph and a second node from the knowledge graph corresponds to a same entity (block 580). For example, the entity analysis platform (e.g., using computing resource 315, processor 420, memory 430, and/or the like) may determine a probability that a first node from the knowledge graph and a second node from the knowledge graph corresponds to a same entity, as described above.

As further shown in FIG. 5, process 500 may include performing an action associated with the probability that the first node and the second node corresponds to the same entity (block 590). For example, the entity analysis platform (e.g., using computing resource 315, processor 420, memory 430, output component 460, communication interface 470, and/or the like) may perform an action associated with the probability that the first node and the second node corresponds to the same entity, as described above.

Process 500 may include additional implementations, such as any single implementation or any combination of implementations described below and/or in connection with one or more other processes described elsewhere herein.

In some implementations, the entity analysis platform, when receiving the unstructured data, may obtain at least one of a webpage, a social media post, or electronic article via a network. In some implementations, the unstructured data includes data from at least one of the webpage, the social media post, or the electronic article. In some implementations, the first plurality of entities are identified using an entity recognition model and the second plurality of entities are identified in the structured data using the entity recognition model that was trained using machine learning. In some implementations, the structured data comprises data from a data structure that is associated with a characteristic of the unstructured data.

In some implementations, the entity analysis platform, when determining the probability that the first node and the second node correspond to the same entity may determine one or more other nodes to which the first node is linked and determine one or more other nodes to which the second node is linked. The entity analysis platform may determine a first probability weighting associated with each link between the first node and the one or more other nodes and determine a second probability weighting associated with each link between the second node and the one or more other nodes. The entity analysis platform may determine the probability that the first node and the second node correspond to the same entity based on the first probability weighting and the second probability weighting.

In some implementations, the entity analysis platform, when performing the action, may send information identifying the probability that the first entity corresponds to the second entity to a user device to permit the user device to display the information identifying the probability. In some implementations, the entity analysis platform, when performing the action, may determine that the probability satisfies a threshold probability that the first entity corresponds to the second entity, analyze the unstructured data to determine a characteristic of the unstructured data based on determining that the probability satisfies the threshold probability; and designate that the second entity is associated with the characteristic.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

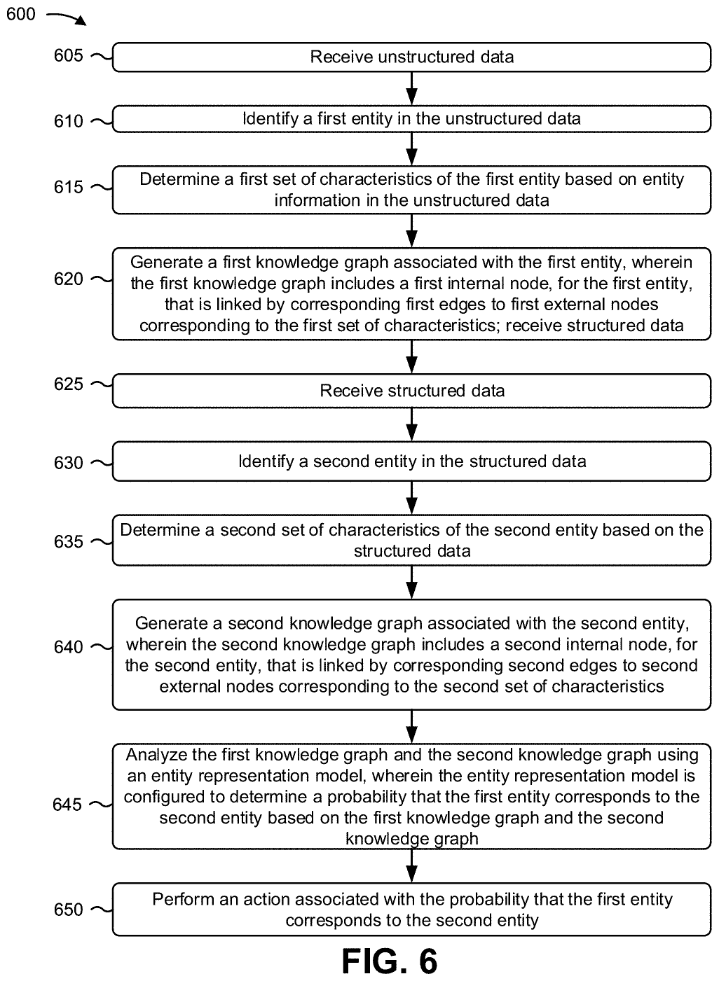

FIG. 6 is a flow chart of an example process 600 for identifying an entity representation in unstructured data. In some implementations, one or more process blocks of FIG. 6 may be performed by an entity analysis platform (e.g., entity analysis platform 310). In some implementations, one or more process blocks of FIG. 6 may be performed by another device or a group of devices separate from or including entity analysis platform 310, such as unstructured data device 305 and/or user device 340.

As shown in FIG. 6, process 600 may include receiving unstructured data (block 605). For example, the entity analysis platform (e.g., using computing resource 315, processor 420, memory 430, input component 450, communication interface 470, and/or the like) may receive unstructured data, as described above.

As further shown in FIG. 6, process 600 may include identifying a first entity in the unstructured data (block 610). For example, the entity analysis platform (e.g., using computing resource 315, processor 420, memory 430, and/or the like) may identify a first entity in the unstructured data, as described above.

As further shown in FIG. 6, process 600 may include determining a first set of characteristics of the first entity based on entity information in the unstructured data (block 615). For example, the entity analysis platform (e.g., using computing resource 315, processor 420, memory 430, and/or the like) may determine a first set of characteristics of the first entity based on entity information in the unstructured data, as described above.

As further shown in FIG. 6, process 600 may include generating a first knowledge graph associated with the first entity, wherein the first knowledge graph includes a first internal node, for the first entity, that is linked by corresponding first edges to first external nodes corresponding to the first set of characteristics (block 620). For example, the entity analysis platform (e.g., using computing resource 315, processor 420, memory 430, and/or the like) may generate a first knowledge graph associated with the first entity, as described above. In some implementations, the first knowledge graph includes a first internal node, for the first entity, that is linked by corresponding first edges to first external nodes corresponding to the first set of characteristics.

As further shown in FIG. 6, process 600 may include receiving structured data (block 625). For example, the entity analysis platform (e.g., using computing resource 315, processor 420, memory 430, input component 450, communication interface 470, and/or the like) may receive structured data, as described above.

As further shown in FIG. 6, process 600 may include identifying a second entity in the structured data (block 630). For example, the entity analysis platform (e.g., using computing resource 315, processor 420, memory 430, and/or the like) may identify a second entity in the structured data, as described above.

As further shown in FIG. 6, process 600 may include determining a second set of characteristics of the second entity based on the structured data (block 635). For example, the entity analysis platform (e.g., using computing resource 315, processor 420, memory 430, and/or the like) may determine a second set of characteristics of the second entity based on the structured data, as described above.

As further shown in FIG. 6, process 600 may include generating a second knowledge graph associated with the second entity, wherein the second knowledge graph includes a second internal node, for the second entity, that is linked by corresponding second edges to second external nodes corresponding to the second set of characteristics (block 640). For example, the entity analysis platform (e.g., using computing resource 315, processor 420, memory 430, and/or the like) may generate a second knowledge graph associated with the second entity, as described above. In some implementations, the second knowledge graph includes a second internal node, for the second entity, that is linked by corresponding second edges to second external nodes corresponding to the second set of characteristics.

As further shown in FIG. 6, process 600 may include analyzing the first knowledge graph and the second knowledge graph using an entity resolution model, wherein the entity resolution model is configured to determine a probability that the first entity corresponds to the second entity based on the first knowledge graph and the second knowledge graph (block 645). For example, the entity analysis platform (e.g., using computing resource 315, processor 420, memory 430, and/or the like) may analyze the first knowledge graph and the second knowledge graph using an entity resolution model, as described above. In some implementations, the entity resolution model is configured to determine a probability that the first entity corresponds to the second entity based on the first knowledge graph and the second knowledge graph.

As further shown in FIG. 6, process 600 may include performing an action associated with the probability that the first entity corresponds to the second entity (block 650). For example, the entity analysis platform (e.g., using computing resource 315, processor 420, memory 430, output component 460, communication interface 470, and/or the like) may perform an action associated with the probability that the first entity corresponds to the second entity, as described above.

Process 600 may include additional implementations, such as any single implementation or any combination of implementations described below and/or in connection with one or more other processes described elsewhere herein.

In some implementations, the entity resolution model has been trained using a machine learning module to determine that the first entity corresponds to the second entity when the probability satisfies a threshold probability. In some implementations, the threshold probability is configured based on the machine learning module.

In some implementations, the first entity is identified in the unstructured data using an entity recognition model and the second entity is identified in the structured data using the entity recognition model. In some implementations, the entity recognition model has been trained using machine learning to determine respective probabilities that the first entity and the second entity are entities.

In some implementations, the first set of characteristics of the first entity are determined using an entity relation model and the second set of characteristics of the second entity are determined using the entity relation model. In some implementations, the entity relation model has been trained using machine learning to determine respective probabilities that the first entity is associated with the first set of characteristics and the second entity is associated with the second set of characteristics.

In some implementations, the unstructured data is received from at least two of: a website, a social media platform, or an online data stream. In some implementations, the structured data is received from a data structure associated with the entity information.

In some implementations, the entity analysis platform, when performing the action, may determine that the probability satisfies a threshold probability that the first entity corresponds to the second entity, determine, from the unstructured data, a sentiment of the first entity and the second entity based on determining that the probability satisfies the threshold probability, and indicate that the second entity is associated with the sentiment

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

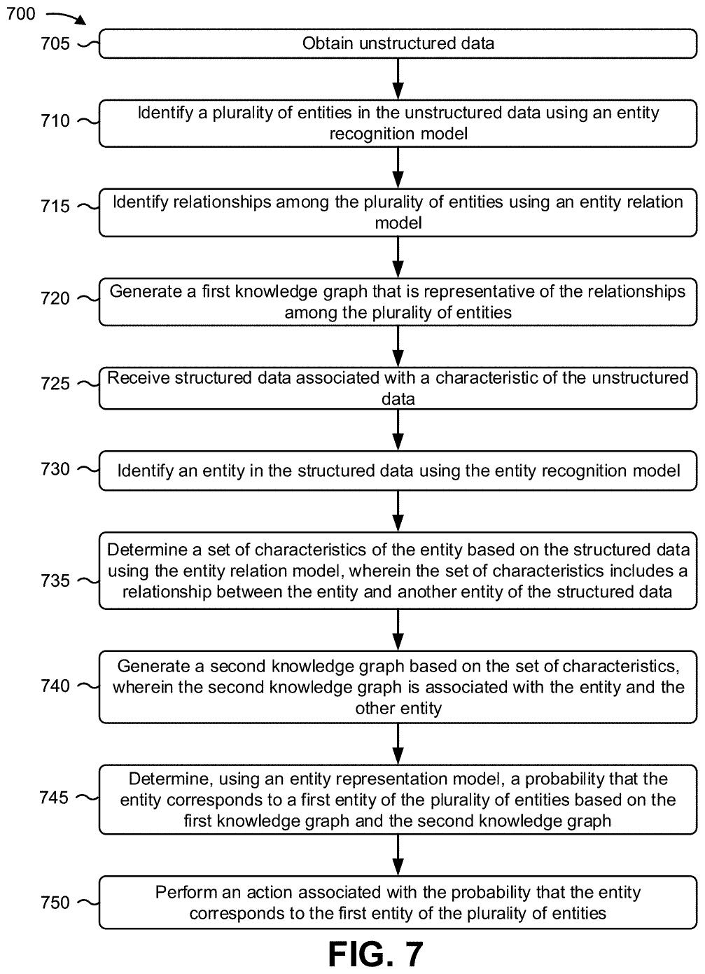

FIG. 7 is a flow chart of an example process 700 for identifying an entity representation in unstructured data. In some implementations, one or more process blocks of FIG. 7 may be performed by an entity analysis platform (e.g., entity analysis platform 310). In some implementations, one or more process blocks of FIG. 7 may be performed by another device or a group of devices separate from or including entity analysis platform 310, such as unstructured data device 305 and/or user device 340.

As shown in FIG. 7, process 700 may include obtaining unstructured data (block 705). For example, the entity analysis platform (e.g., using computing resource 315, processor 420, memory 430, input component 450, communication interface 470, and/or the like) may obtain unstructured data, as described above.

As further shown in FIG. 7, process 700 may include identifying a plurality of entities in the unstructured data using an entity recognition model (block 710). For example, the entity analysis platform (e.g., using computing resource 315, processor 420, memory 430, and/or the like) may identify a plurality of entities in the unstructured data using an entity recognition model, as described above.

As further shown in FIG. 7, process 700 may include identifying relationships among the plurality of entities using an entity relation model (block 715). For example, the entity analysis platform (e.g., using computing resource 315, processor 420, memory 430, and/or the like) may identify relationships among the plurality of entities using an entity relation model, as described above.

As further shown in FIG. 7, process 700 may include generating a first knowledge graph that is representative of the relationships among the plurality of entities (block 720). For example, the entity analysis platform (e.g., using computing resource 315, processor 420, memory 430, and/or the like) may generate a first knowledge graph that is representative of the relationships among the plurality of entities, as described above.

As further shown in FIG. 7, process 700 may include receiving structured data associated with a characteristic of the unstructured data (block 725). For example, the entity analysis platform (e.g., using computing resource 315, processor 420, memory 430, input component 450, communication interface 470, and/or the like) may receive structured data associated with a characteristic of the unstructured data, as described above.

As further shown in FIG. 7, process 700 may include identifying an entity in the structured data using the entity recognition model (block 730). For example, the entity analysis platform (e.g., using computing resource 315, processor 420, memory 430, input component 450, output component 460, communication interface 470, and/or the like) may identify an entity in the structured data using the entity recognition model, as described above.

As further shown in FIG. 7, process 700 may include determining a set of characteristics of the entity based on the structured data using the entity relation model, wherein the set of characteristics includes a relationship between the entity and another entity of the structured data (block 735). For example, the entity analysis platform (e.g., using computing resource 315, processor 420, memory 430, and/or the like) may determine a set of characteristics of the entity based on the structured data using the entity relation model, as described above. In some implementations, the set of characteristics includes a relationship between the entity and another entity of the structured data.

As further shown in FIG. 7, process 700 may include generating a second knowledge graph based on the set of characteristics, wherein the second knowledge graph is associated with the entity and the other entity (block 740). For example, the entity analysis platform (e.g., using computing resource 315, processor 420, memory 430, and/or the like) may generate a second knowledge graph based on the set of characteristics, as described above. In some implementations, the second knowledge graph is associated with the entity and the other entity.

As further shown in FIG. 7, process 700 may include determining, using an entity resolution model, a probability that the entity corresponds to a first entity of the plurality of entities based on the first knowledge graph and the second knowledge graph (block 745). For example, the entity analysis platform (e.g., using computing resource 315, processor 420, memory 430, and/or the like) may determine, using an entity resolution model, a probability that the entity corresponds to a first entity of the plurality of entities based on the first knowledge graph and the second knowledge graph, as described above.

As further shown in FIG. 7, process 700 may include performing an action associated with the probability that the entity corresponds to the first entity of the plurality of entities (block 750). For example, the entity analysis platform (e.g., using computing resource 315, processor 420, memory 430, output component 460, communication interface 470, and/or the like) may perform an action associated with the probability that the entity corresponds to the first entity of the plurality of entities, as described above.

Process 700 may include additional implementations, such as any single implementation or any combination of implementations described below and/or in connection with one or more other processes described elsewhere herein.

In some implementations, the entity resolution model is to calculate the probability based on representations of the set of characteristics, the entity, and the other entity in the second knowledge graph corresponding to representations of the first knowledge graph that are associated with the first entity.

In some implementations, the probability is a first probability, and the entity analysis platform may determine using the entity resolution model, a second probability that the entity corresponds to a second entity of the plurality of entities based on the first knowledge graph and the second knowledge graph and perform an action associated with the second probability that the entity corresponds to the second entity.

In some implementations, the entity analysis platform, when performing the action associated with the second probability, may determine that the first probability and the second probability satisfy a threshold probability; and indicate that the first entity and the second entity correspond to the entity.

In some implementations, the unstructured data is obtained via a web crawler that obtains the unstructured data from one or more online platforms. In some implementations, at least one of the entity recognition model, the entity relation model, or the entity resolution model was trained using machine learning.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, unstructured data;
identifying, by the device, a first plurality of entities in the unstructured data;
identifying, by the device, first relationships associated with the first plurality of entities using an entity relation model;
receiving, by the device, structured data;
identifying, by the device, a second plurality of entities in the structured data;
identifying, by the device, second relationships associated with the second plurality of entities using the entity relation model;
generating, by the device, a knowledge graph that is representative of the first plurality of entities,
wherein the first relationships are associated with the first plurality of entities and the second relationships are associated with the second plurality of entities;
determining, by the device, a probability that a first node from the knowledge graph and a second node from the knowledge graph corresponds to a same entity; and
performing, by the device, an action associated with the probability that the first node and the second node corresponds to the same entity.

2. The method of claim 1, wherein receiving the unstructured data comprises:
obtaining at least one of a webpage, a social media post, or electronic article via a network,
wherein the unstructured data includes data from at least one of the webpage, the social media post, or the electronic article.

3. The method of claim 1, wherein the first plurality of entities are identified using an entity recognition model and the second plurality of entities are identified in the structured data using the entity recognition model that was trained using machine learning.

4. The method of claim 1, wherein the structured data comprises data from a data structure that is associated with a characteristic of the unstructured data.

5. The method of claim 1, wherein determining the probability that the first node and the second node correspond to the same entity comprises:
determining one or more other nodes to which the first node is linked,
determining one or more other nodes to which the second node is linked,
determining a first probability weighting associated with each link between the first node and the one or more other nodes;
determining a second probability weighting associated with each link between the second node and the one or more other nodes; and
determining the probability that the first node and the second node correspond to the same entity based on the first probability weighting and the second probability weighting.

6. The method of claim 1, wherein performing the action comprises:
sending information identifying the probability that the first entity corresponds to the second entity to a user device to permit the user device to display the information identifying the probability.

7. The method of claim 1, wherein performing the action comprises:
determining that the probability satisfies a threshold probability that the first entity corresponds to the second entity;
analyzing the unstructured data to determine a characteristic of the unstructured data based on determining that the probability satisfies the threshold probability; and
designating that the second entity is associated with the characteristic.

8. A device, comprising:
one or more memories; and
one or more processors, communicatively coupled to the one or more memories, to:
receive unstructured data;
identify a first entity in the unstructured data;
determine a first set of characteristics of the first entity based on entity information in the unstructured data;
generate a first knowledge graph associated with the first entity,
wherein the first knowledge graph includes a first internal node, for the first entity, that is linked by corresponding first edges to first external nodes corresponding to the first set of characteristics;
receive structured data;
identify a second entity in the structured data;
determine a second set of characteristics of the second entity based on the structured data;
generate a second knowledge graph associated with the second entity,
wherein the second knowledge graph includes a second internal node, for the second entity, that is linked by corresponding second edges to second external nodes corresponding to the second set of characteristics;
analyze the first knowledge graph and the second knowledge graph using an entity resolution model,
wherein the entity resolution model is configured to determine a probability that the first entity corresponds to the second entity based on the first knowledge graph and the second knowledge graph; and
perform an action associated with the probability that the first entity corresponds to the second entity.

9. The device of claim 8, wherein the entity resolution model has been trained using a machine learning module to determine that the first entity corresponds to the second entity when the probability satisfies a threshold probability,
wherein the threshold probability is configured based on the machine learning module.

10. The device of claim 8, wherein the first entity is identified in the unstructured data using an entity recognition model and the second entity is identified in the structured data using the entity recognition model,
wherein the entity recognition model has been trained using machine learning to determine respective probabilities that the first entity and the second entity are entities.

11. The device of claim 8, wherein the first set of characteristics of the first entity are determined using an entity relation model and the second set of characteristics of the second entity are determined using the entity relation model,
wherein the entity relation model has been trained using machine learning to determine respective probabilities that the first entity is associated with the first set of characteristics and the second entity is associated with the second set of characteristics.

12. The device of claim 8, wherein the unstructured data is received from at least two of:
a website;
a social media platform; or
an online data stream.

13. The device of claim 8, wherein the structured data is received from a data structure associated with the entity information.

14. The device of claim 8, wherein the one or more processors, when performing the action, are to:
determine that the probability satisfies a threshold probability that the first entity corresponds to the second entity;
determine, from the unstructured data, a sentiment of the first entity and the second entity based on determining that the probability satisfies the threshold probability; and
indicate that the second entity is associated with the sentiment.

15. A non-transitory computer-readable medium storing instructions, the instructions comprising:
one or more instructions that, when executed by one or more processors, cause the one or more processors to:
obtain unstructured data;
identify a plurality of entities in the unstructured data using an entity recognition model;
identify relationships among the plurality of entities using an entity relation model;
generate a first knowledge graph that is representative of the relationships among the plurality of entities;
receive structured data associated with a characteristic of the unstructured data;
identify an entity in the structured data using the entity recognition model;
determine a set of characteristics of the entity based on the structured data using the entity relation model,
wherein the set of characteristics includes a relationship between the entity and another entity of the structured data;
generate a second knowledge graph based on the set of characteristics,
wherein the second knowledge graph is associated with the entity and the other entity;
determine, using an entity resolution model, a probability that the entity corresponds to a first entity of the plurality of entities based on the first knowledge graph and the second knowledge graph; and
perform an action associated with the probability that the entity corresponds to the first entity of the plurality of entities.

16. The non-transitory computer-readable medium of claim 15, wherein the entity resolution model is to calculate the probability based on representations of the set of characteristics, the entity, and the other entity in the second knowledge graph corresponding to representations of the first knowledge graph that are associated with the first entity.

17. The non-transitory computer-readable medium of claim 15, wherein the probability is a first probability, and the one or more instructions, when executed by the one or more processors, further cause the one or more processors to:
determine using the entity resolution model, a second probability that the entity corresponds to a second entity of the plurality of entities based on the first knowledge graph and the second knowledge graph; and
perform an action associated with the second probability that the entity corresponds to the second entity.

18. The non-transitory computer-readable medium of claim 17, wherein the one or more instructions, that cause the one or more processors to perform the action associated with the second probability, cause the one or more processors to:
determine that the first probability and the second probability satisfy a threshold probability; and
indicate that the first entity and the second entity correspond to the entity.

19. The non-transitory computer-readable medium of claim 15, wherein the unstructured data is obtained via a web crawler that obtains the unstructured data from one or more online platforms.

20. The non-transitory computer-readable medium of claim 15, wherein at least one of the entity recognition model, the entity relation model, or the entity resolution model was trained using machine learning.
